(19) United States
(12) Patent Application Publication
(10) Pub. No.: US 2017/0100744 A1
(43) Pub. Date: Apr. 13, 2017

(54) Electronic Component and Process of Producing Electronic Component

(71) Applicant: Tyco Electronics Corporation, Berwyn, PA (US)

(72) Inventors: Shallu Soneja, Mountain View, CA (US); Min Zheng, San Francisco, CA (US); Dov Nitzan, San Jose, CA (US); Lavanya Bharadwaj, Dublin, CA (US); Barry C. Mathews, Fremont, CA (US); Michael A. Oar, San Francisco, CA (US); Gokce Gulsoy, San Jose, CA (US)

(73) Assignee: Tyco Electronics Corporation, Berwyn, PA (US)

(21) Appl. No.: 14/881,051

(22) Filed: Oct. 12, 2015

(51) Int. Cl. B05D 3/06

(52) U.S. Cl. CPC B05D 3/06

(57) ABSTRACT

Electronic components and processes of producing electronic components are disclosed. The electronic component includes a substrate, a first layer on the substrate, a rapidly solidified layer on the first layer and a conductive layer positioned on the rapidly solidified layer. The rapidly solidified layer includes a metastable phase.

### FIELD OF THE INVENTION

The present invention is directed to electronic components and processes of producing electronic components. More particularly, the present invention is directed to components and processes including a rapidly solidified layer.

### BACKGROUND OF THE INVENTION

Deposition of conductive inks via different printing technologies is a growing field, with limitations on compatibility for existing techniques. Such limitations render it difficult to utilize the perceived selectivity and ability to produce lower feature-sized electrical contacts. For example, reliance upon metallization techniques on printed features is problematic because they are very complicated thermodynamic and kinetic processes.

Flexibility and breadth of use for electrical contact layers is highly desirable. Prior techniques have not had sufficient control of properties associated with electrical contact layers and, thus, have been limited in application. For example, prior techniques have not adequately permitted inclusion of nanocrystalline structures and/or amorphous structures, permitted creation of medium or larger grains, permitted pore-free or substantially pore-free layers, permitted a gradient of elemental or compositional metals or alloys, permitted formation of a grain boundary strengthened by grain boundary engineering, permitted grain pinning, permitted higher surface hardness, permitted higher wear resistance, permitted diffusion of elements or formation of an interdiffusion layer, permitted higher corrosion resistance, or permitted combinations thereof.

Electroplating has been used to deposit amorphous metal diffusion barriers which have shown improved properties in electrical contact. (See European Publication No. 0160761 B1, “Amorphous Transition Metal Alloy, thin gold coated, electrical contact”, published Feb. 8, 1989.)

Electroplating of electrical contacts is a common process which requires large volumes of plating bath chemicals, large area physical footprint, and consumes large quantities of precious metals. Due to environmental regulations, electroplating lines are typically segregated to specific geographic zones and undergo high levels of regulatory scrutiny.

One known process for treating of metal surfaces is laser surface treatment. The laser surface treatment has been shown to produce glassy metals. (C. W. Draper, “Laser Surface Alloying of Gold”, GoldBull., 1986, 19, (1). However, efficiency of laser beam absorption, depends on the reflectivity of the targets. Reflectivity of a metal surface can be greatly impacted by the presence of surface films. In addition, the depth of penetration (DoP)/heated depth for laser surface treatments is less than electron beam sources. Therefore, a greater number of passes to heat a bulk volume are required. Further, laser surface treatments have lower power density, which increases the processing times for large scale manufacturing. Likewise, laser surface treatments generally have slower beam deflection than electron beam sources, which likewise results in longer processing times. Further still, known laser surface treatments have a greater susceptibility to contamination due to the processing environment, compared to electron beam processing.

An electronic component and process of producing an electronic component that show one or more improvements in comparison to the prior art would be desirable in the art.

### BRIEF DESCRIPTION OF THE INVENTION

In an embodiment, an electronic component includes a substrate, a first layer on the substrate, a rapidly solidified layer on the first layer and a conductive layer positioned on the rapidly solidified layer. The rapidly solidified layer includes a metastable phase.

In another embodiment, an electronic component includes a substrate, a nickel-containing first layer on the substrate, a rapidly solidified layer on the nickel-containing first layer and a conductive layer positioned on the rapidly solidified layer. The rapidly solidified layer includes a metastable phase comprising nickel from the nickel-containing first layer and a conductive metal from the conductive layer.

In another embodiment, a process of producing an electronic component includes providing a substrate, applying a first layer to the substrate, and applying a conductive layer to the substrate. The method further includes directing an energetic beam to at least a portion of each of the first layer and conductive layer to form a rapidly solidified layer comprising a metastable phase.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic drawing of an electrical component, according to an embodiment of the disclosure.

FIG. 2 is a schematic drawing of a method of forming an electrical component, according to an embodiment of the disclosure.

FIG. 3 is a process flow diagram of a method of forming an electrical component, according to an embodiment of the disclosure.

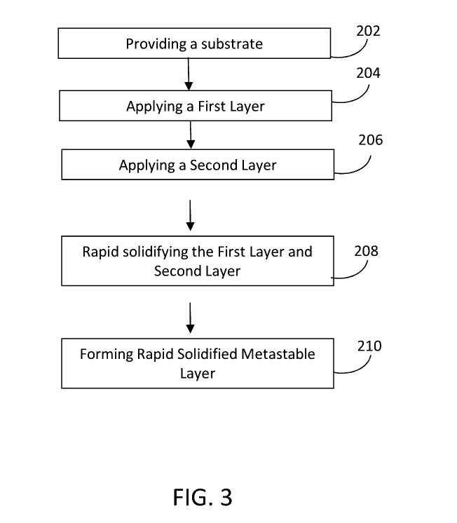

FIG. 4 is a micrograph of electric contact layers on embodiments of an electronic component formed via a process, according to the present disclosure.

FIG. 5 is a micrograph of electric contact layers on embodiments of an electronic component formed via a process, according to the present disclosure.

Wherever possible, the same reference numbers will be used throughout the drawings to represent the same parts.

### DETAILED DESCRIPTION OF THE INVENTION

Provided are electronic components and processes of producing electronic components. Embodiments of the present disclosure, for example, in comparison to concepts failing to include one or more of the features disclosed herein, permit inclusion of nanocrystalline structures and/or amorphous structures, permit creation of medium or larger grains, such as grains from about 0.5 μm to about 4 μm, permit pore-free or substantially pore-free layers, permit a gradient of elemental or compositional metals or alloys, permit formation of a grain boundary strengthened by grain boundary engineering via alloying element/compound additions, permit formation of a grain boundary pinning via alloying elements and insoluble particle, permit higher surface hardness, permit higher wear resistance, permit diffusion of elements or formation of an interdiffusion layer, permit higher corrosion resistance, or permit combinations thereof. The method, according to embodiments of the present disclosure, includes a process that is more environmentally friendly and includes selective deposition of precious metals that do not require electroplating. Processes, according to embodiments of the present disclosure, include higher throughput speeds, smaller footprint, and reduced precious metal consumption. In addition to process advantages, the technique generates desirable grain structures, alloys, and microstructures that provide desired physical properties.

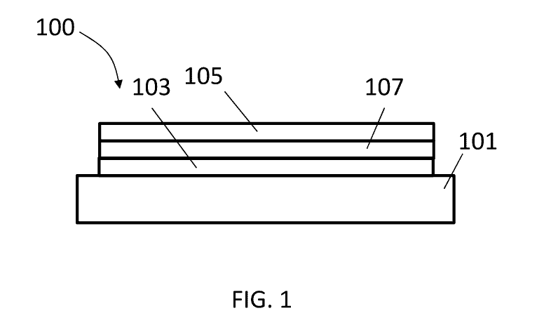

Referring to FIG. 1, according to an embodiment the disclosure, an electronic component 100 includes a substrate 101, a first layer 103, a conductive layer 105 and a rapidly solidified layer 107. The substrate 101 is not particularly limited and may be any suitable substrate material. For example, suitable substrate materials include, but are not limited to, copper (Cu), copper alloys, nickel (Ni), nickel alloys, aluminum (Al), aluminum alloys, steel, steel derivatives, or combinations thereof. In an exemplary embodiment, the first layer 103 is sprayed, printed or electroplated onto substrate 101. The first layer 103 is applied to provide a barrier layer to reduce or eliminate diffusion of the substrate 101 into the conductive layer 105. In one embodiment, the first layer 103 has diffusion rates slower than diffusion coefficient of copper in pure nickel, such as 1.85×10⁻²⁰ [m²/s] at 449° C.-3.98×10⁻¹⁵ [m²/s] at 1064° C.

A material and/or coating for additional corrosion resistance of the substrate 101 may be applied, for example, to an area surrounding the first layer 103 and conductive layer 105, or contact point, on substrate 101. The area surrounding the first layer 103 and conductive layer 105 having the additional material and/or coating may provide greater corrosion resistance to the coated substrate than the contact point (i.e., the combination of the first layer 103 and conductive layer 105) itself. In particular, lower-grade metallic materials may be contained in the material coating of the region surrounding the contact point than in the material coating of the contact point.

The rapidly solidified layer 107 is an energetic beam remelted layer forming a rapidly solidified layer 107 having a microstructural modification from rapid solidification. The first layer 103 includes any suitable barrier material, such as, but not limited to, nickel (Ni), titanium (Ti), molybdenum (Mo), tungsten (W), tantalum (Ta), niobium (Nb), zirconium (Zr), vanadium (V), chromium (Cr), iron (Fe), cobalt (Co), manganese (Mn), iron (Fe), hafnium (Hf), rhenium (Re), zinc (Zn), or a combination thereof. The conductive layer 105 includes any suitable conductive material, such as, but not limited to, gold (Au), silver (Ag), tin (Sn), molybdenum (Mo), titanium (Ti), palladium (Pd), platinum (Pt), rhodium (Rh), iridium (Ir), aluminum (Al), ruthenium (Ru), or combinations thereof. In addition, in one embodiment, conductive layer 105 includes Au in combination with boron (B), silicon (Si), bismuth (Bi), germanium (Ge), or a combination thereof.

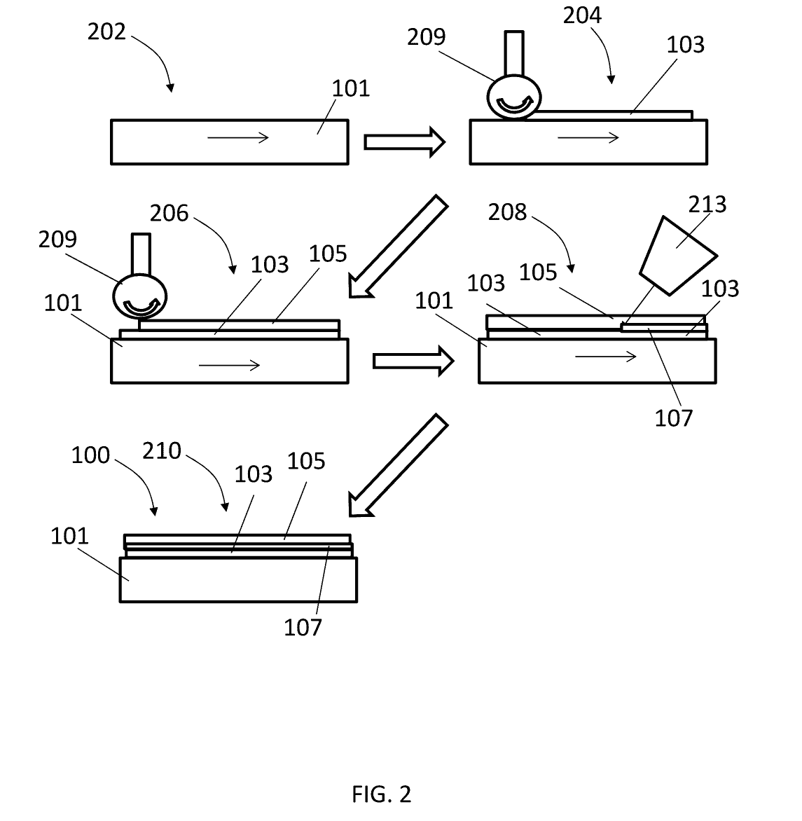

FIG. 2 shows a process of forming the electronic component 100, according to the present disclosure. As shown in FIG. 2, substrate 101 is provided (step 202), thereafter a first layer 103 containing metal is applied to substrate 101 (step 204). While the first layer 103 is shown as being applied by roll coating by a roller 209, the process is not so limited. Thereafter, a conductive layer 105 containing metal is applied to first layer 103 (step 206). For example, in other exemplary embodiments, the first layer 103 and the conductive layer 105 are sprayed or printed. In other embodiments, the first layer 103 and the conductive layer 105 are electroplated, printed, or otherwise applied onto the substrate 101. After the application of the conductive layer 105, the first layer 103 and conductive layers 105 are modified with an energetic beam 213 to form a rapidly solidified layer 107 which includes a metastable phase (step 208). In the example shown in FIG. 2, the rapid solidification is performed with an energetic beam melting. However, the rapid solidification can be performed by other techniques, such as, but are not limited to, applying a continuous energetic beam (for example, from a CO₂ laser or electron beam), applying a pulsed energetic beam (for example, from a neodymium yttrium aluminum garnet laser), applying a focused beam, applying a defocused beam, or performing any other suitable beam-based technique. Rapid solidification includes any suitable parameters, such as, penetration depths, pulse duration, beam diameters (at contact point), beam intensity, and wavelength to form rapidly solidified structure. Once the rapid solidification is completed, the electronic component 100 including the microstructure having metastable phase is formed (step 210). Further steps, such as annealing, may be performed.

In another embodiment, the rapidly solidified layer 107 is an exposed contact surface or top layer. In this embodiment, the conductive layer 105 may be converted entirely or substantially entirely to a rapidly solidified layer 107, such as under increased energetic beam power or increased process time. In other embodiments, the interface of the first and conductive layers is arranged such that a contact surface comprising the rapidly solidified layer 107 is an exposed contact surface or formed as a top layer.

Rapid solidification, as utilized herein, is an enhancement or otherwise a modification to a metallic structure of a deposited metal to form a metastable microstructure. Rapid solidification is provided by a remelting of a metal deposited on substrate 101 utilizing an energetic beam. While not wishing to be bound by theory or explanation, the rapid temperature rise and quench, such as from the electron beam process, is believed to form the metastable states and metastable alloy microstructures. A metastable alloy microstructure is a mixed metal system which shows thermodynamically non-equilibrium structures and properties that are not formed through standard conditions of slow heating and cooling. As utilized herein, “metastable” and grammatical variations thereof, include amorphous metallic systems that are non-crystalline and/or comprised of atoms arranged in a spatial pattern that does not exhibit long-range order and/or comprised of highly randomly arranged crystals exhibiting short range order no more than a few to several interatomic spacings. The metastable, amorphous, metallic systems may include non-equilibrium solid solution alloys featuring compositions and atomic arrangements/crystal structures or intermetallic phases different than those predicted by equilibrium phase diagrams. The metastable system is capable of transition to a more thermodynamically favorable state with the addition of a small amount of energy. For example, isothermal heating at or above the glass transition temperature or crystallization temperature will revert the metastable state to a thermodynamically favorable state.

The energetic beam remelting is achieved by any suitable techniques. Suitable techniques include, but are not limited to, applying a continuous energetic beam (for example, from a CO₂ laser or electron beam), applying a pulsed energetic beam (for example, from a neodymium yttrium aluminum garnet laser), applying a focused beam, applying a defocused beam, or performing any other suitable beam-based technique. Energetic beam remelting is with any suitable parameters, such as, penetration depths, pulse duration, beam diameters (at contact point), beam intensity, and wavelength.

Suitable penetration depths depend upon the composition and the beam energies. For example, for Cu or Cu-containing compositions, suitable penetration depths at 20 kV include, but are not limited to, between 1 and 2 micrometers, between 1 and 1.5 micrometers, between 1.2 and 1.4 micrometers, or any suitable combination, sub-combination, range, or sub-range therein. For Cu or Cu-containing compositions, suitable penetration depths at 60 kV include, but are not limited to, between 7 and 9 micrometers, between 7.5 and 8.5 micrometers, between 7.8 and 8.2 micrometers, or any suitable combination, sub-combination, range, or sub-range therein.

For Ag or Ag-containing compositions, suitable penetration depths at 20 kV include, but are not limited to, between 1 and 2 micrometers, between 1 and 1.5 micrometers, between 1.2 and 1.4 micrometers, or any suitable combination, sub-combination, range, or sub-range therein. For Ag or Ag-containing compositions, suitable penetration depths at 60 kV include, but are not limited to, between 8 and 9 micrometers, between 8.2 and 8.8 micrometers, between 8.4 and 8.6 micrometers, or any suitable combination, sub-combination, range, or sub-range therein.

For Au or Au-containing compositions, suitable penetration depths at 20 kV include, but are not limited to, between 0.5 and 1.5 micrometers, between 0.7 and 1.3 micrometers, between 0.8 and 1 micrometers, or any suitable combination, sub-combination, range, or sub-range therein. For Au or Au-containing compositions, suitable penetration depths at 60 kV include, but are not limited to, between 3 and 7 micrometers, between 4 and 6 micrometers, between 4.5 and 5.5 micrometers, or any suitable combination, sub-combination, range, or sub-range therein.

Suitable pulse durations include, but are not limited to, between 4 and 24 microseconds, between 12 and 100 microseconds, between 72 and 200 microseconds, between 100 and 300 microseconds, between 250 and 500 microseconds, between 500 and 1,000 microseconds, or any suitable combination, sub-combination, range, or sub-range therein.

Suitable beam widths include, but are not limited to, between 25 and 50 micrometers, between 30 and 40 micrometers, between 30 and 100 micrometers, between 100 and 150 micrometers, between 110 and 130 micrometers, between 120 and 140 micrometers, between 200 and 600 micrometers, between 200 and 1,000 micrometers, between 500 and 1,500 micrometers, or any suitable combination, sub-combination, range, or sub-range therein.

Suitable beam intensities include, but are not limited to, having a power output of between 2,000 watts to 10 kilowatts, between 10 kilowatts to 30 kilowatts, between 30 to 100 kilowatts, between 0.1 and 2,000 watts, between 1,100 and 1,300 watts, between 1,100 and 1,400 watts, between 1,000 and 1,300 watts, between 50 and 900 watts, between 4.5 and 60 watts, between 1 and 2 watts, between 1.2 and 1.6 watts, between 1.2 and 1.5 watts, between 1.3 and 1.5 watts, between 200 and 250 milliwatts, between 220 and 240 milliwatts, or any suitable combination, sub-combination, range, or sub-range therein.

In embodiments utilizing the laser for the energetic beam remelting, suitable wavelengths include, but are not limited to, between 10 and 11 micrometers, between 9 and 11 micrometers, between 10.5 and 10.7 micrometers, between 1 and 1.1 micrometers, between 1.02 and 1.08 micrometers, between 1.04 and 1.08 micrometers, between 1.05 and 1.07 micrometers, or any suitable combination, sub-combination, range, or sub-range therein.

The rapidly solidified layer 107 has a composition based upon the conditions of the energetic beam remelting and the compositions/purity of the first layer 103 and/or the conductive layer 105. In one embodiment, the rapidly solidified layer 107 has between 40 wt % and 60 wt % gold. In another embodiment, the rapidly solidified layer 107 has between 40 wt % and 60 wt % nickel. In further embodiments, the rapidly solidified layer 107 has a nickel to gold ratio of between 0.7 to 1.3 and 1.3 to 0.7, 0.8 to 1.2 and 1.2 to 0.8, between 0.9 to 1.1 and 1.1 to 0.9, or any suitable combination, sub-combination, range, or sub-range therein.

The metastable microstructures exhibit properties of amorphous metals typically referred to as bulk metallic glasses. The metastable microstructure includes 1) metastable mixed alloy microstructures and 2) metallic glasses. Metastable microstructures have been shown to display novel physical properties including reduced diffusion rates, improved wear properties, and improved corrosion resistance. For example, in one embodiment, the contact surface including the rapidly solidified layer 107 has wear friction properties, including a coefficient of friction between 0.2-0.5 for 200 cycles under 50 g force upon exposure to N, S, O, Cl containing environment (Standard MFG Class IIA—5 day testing). Further, the contact surface, including the rapidly solidified layer 107, has corrosion resistance wherein the material passes standard MFG Class IIA at 5 days with no fretting and no burnishing during tribology testing. In addition, in one embodiment, rapidly solidified layer 107 includes hardness properties of greater than 200 Knoop under 25 g load.

The thickness/depth of the rapidly solidified layer 107 is also based upon the conditions of the energetic beam remelting and the compositions/purity of the first layer 103 and/or the rapidly solidified layer 107. Suitable thicknesses of the rapidly solidified layer 107 include, but are not limited to, between 0.1 micrometers and 1 micrometer, between 0.3 micrometers and 0.8 micrometers, between 0.4 micrometers and 0.6 micrometers, between 0.3 micrometers and 0.5 micrometers, less than 0.5 micrometers, or any suitable combination, sub-combination, range, or sub-range therein.

The stability of the rapidly solidified layer 107 permits the rapidly solidified layer 107 to remain in a non-equilibrium alloy state within a temperature range for a period of time. In one embodiment, the temperature range is between −23° C. and 300° C., between 0° C. and 200° C., between 0° C. and 100° C., between 0° C. and 50° C., between 15° C. and 30° C., between 20° C. and 25° C., or any suitable combination, sub-combination, range, or sub-range therein. In one embodiment, the period of time is between 1 month and 6 months, between 2 months and 5 months, between 2 months and 4 months, between 3 months and 5 months, or any suitable combination, sub-combination, range, or sub-range therein.

Under reversion conditions, the metastable phase reverts to one or more of a thermodynamically favorable state, equilibrium solid solution state or an intermetallic phase comprised of the first layer and the conductive layer. In one embodiment, the temperature of such conditions is between 400° C. and 600° C., between 450° C. and 550° C., between 480° C. and 520° C., or any suitable combination, sub-combination, range, or sub-range therein. In another embodiment, the temperature range for the reversion to the thermodynamically favorable state, equilibrium solid solution state and/or intermetallic phase comprised of the first layer and the conductive layer includes an isothermal heating to a temperature 30% to 50% of the melting point of the first layer and/or the conductive layer or isothermal heating above the glass transition temperature (Tg) or crystallization temperature of the first layer and/or the conductive layer. In one embodiment, the period of time for such reversion conditions is between 24 hours and 96 hours, between 40 hours and 80 hours, between 40 hours and 60 hours, between 45 hours and 50 hours, or any suitable combination, sub-combination, range, or sub-range therein.

### EXAMPLE

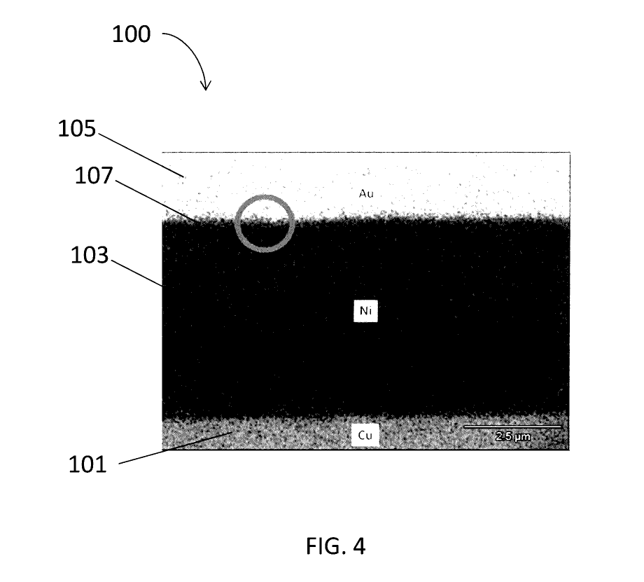

Referring to FIG. 4, according to an embodiment the disclosure, an electronic component 100 includes a copper-containing substrate 101, a nickel-containing first layer 103 on the substrate 101, a rapidly solidified layer 107 on the nickel-containing first layer 103, and a conductive layer 105 positioned on the rapidly solidified layer 107. The rapidly solidified layer 107 includes a metastable phase including alloy of nickel and gold, from the first layer 103 and the conductive layer 105, respectively.

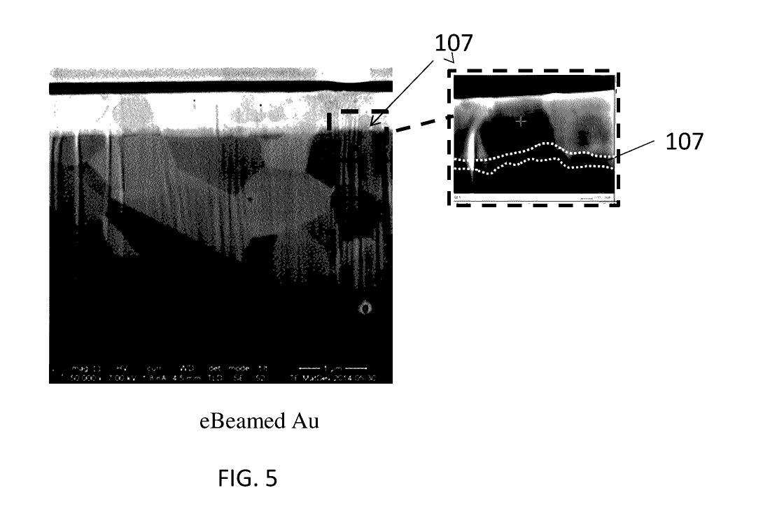

FIG. 5 shows micrographs of electric contact layers on embodiments of an electronic component formed via a process, according to the present disclosure. The structure shown in FIG. 5 includes a layer structure formed, according to the present disclosure, having a rapidly solidified layer 107.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

1. An electronic component, comprising:
a substrate;
a first layer on the substrate;
a rapidly solidified layer on the first layer; and
a conductive layer positioned on the rapidly solidified layer;
wherein the rapidly solidified layer includes a metastable phase.

2. The electronic component of claim 1, wherein metastable phase is an amorphous metallic system.

3. The electronic component of claim 1, wherein metastable phase is a non-equilibrium solid solution alloy.

4. The electronic component of claim 1, wherein the conductive metal is selected from the group consisting of nickel, titanium, molybdenum, tungsten, tantalum, niobium, zirconium, vanadium, chromium, iron, cobalt, and combinations thereof.

5. The electronic component of claim 1, wherein the conductive metal includes silver or gold.

6. The electronic component of claim 1, wherein the first layer includes a material selected from the group consisting of nickel, titanium, molybdenum, tungsten, tantalum, niobium, zirconium, vanadium, chromium, iron, cobalt, manganese, iron, hafnium, rhenium, zinc, and combinations thereof.

7. The electronic component of claim 1, wherein the substrate includes a material selected from the group consisting of copper, copper alloys, nickel, nickel alloys, aluminum, aluminum alloys, steel, steel derivatives, or combinations thereof.

8. The electronic component of claim 1, wherein the rapidly solidified layer remains in a non-equilibrium alloy state for at least 3 months at ambient conditions.

9. The electronic component of claim 1, wherein the rapidly solidified layer reverts to an equilibrium state in response to heat treatment at 500° C. for 48 hours.

10. The electronic component of claim 1, wherein the rapidly solidified layer remains in a non-equilibrium alloy state within a temperature range of between −23° C. and 300° C. for a period of time of at least 1 month, and reverts to one or more of a thermodynamically favorable state, an equilibrium solid solution state or an intermetallic phase comprised of the first layer and the conductive layer at conditions of between 400° C. and 600° C. over between 24 hours and 96 hours.

11. The electronic component of claim 1, wherein the rapidly solidified layer is an electron-beam produced layer.

12. The electronic component of claim 1, wherein the rapidly solidified layer forms an exposed contact surface.

13. The electronic component of claim 1, wherein the rapidly solidified layer has between 40 wt % and 60 wt % gold.

14. The electronic component of claim 1, wherein the rapidly solidified layer has between 40 wt % and 60 wt % nickel.

15. The electronic component of claim 1, wherein the rapidly solidified layer has a nickel to gold ratio of between 0.7 to 1.3 and 1.3 to 0.7.

16. The electronic component of claim 1, wherein the rapidly solidified layer has a thickness of less than 0.5 micrometers.

17. The electronic component of claim 1, wherein the metastable layer is an energetic beam remelted layer formed by an electron beam.

18. The electronic component of claim 1, wherein the metastable layer is an energetic beam remelted layer formed by a laser.

19. An electronic component, comprising:
a substrate;
a nickel-containing first layer on the substrate;
a rapidly solidified layer on the nickel-containing first layer; and
a conductive layer positioned on the metastable metal phase layer;
wherein the rapidly solidified layer includes a metastable phase comprising nickel from the nickel-containing first layer and a conductive metal from the conductive layer.

20. A process of producing an electronic component, the process comprising:
providing a substrate;
applying a first layer to the substrate;
applying a conductive layer to the substrate;
and directing an energetic beam to at least a portion of each of the first layer and conductive layer to form a rapidly solidified layer comprising a metastable phase.
